(19) United States
(12) Patent Application Publication
(10) Pub. No.: US 2025/0304049 A1
(43) Pub. Date: Oct. 2, 2025

(54) DRIVING ASSISTANCE DEVICE AND DRIVING ASSISTANCE METHOD

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Yuki TAKAHASHI, Tokyo (JP); Takeo MIKI, Isehara-shi (JP); Tomoya TAKEDA, Atsugi-shi (JP)

(21) Appl. No.: 19/085,749

(22) Filed: Mar. 20, 2025

(30) Foreign Application Priority Data
Mar. 26, 2024 (JP) 2024-050156

(51) Int. Cl. B60W 30/09; B60W 30/095

(52) U.S. Cl. CPC B60W 30/09; B60W 30/0953; B60W 2420/403; B60W 2420/408

(57) ABSTRACT

A driving assistance device includes: a position detection unit that executes first/second position detection processing to detect a first/second position of an object using output of a first/second sensor; and an operation command generation unit that generates an operation command of a driving assistance operation to reduce a probability of collision using a detection result of the position detection unit. The operation command generation unit executes: first processing that judges a detected state of the object corresponds to which of a plurality of detected states, including a first detected state and a second detected state having detection reliability lower than that of the first detected state; and second processing that sets a target braking force generated by actuation of an automatic braking to a value lower than when corresponding to the first detected state, when a specific condition including corresponding to the second detected state is satisfied.

### CROSS-REFERENCE TO RELATED APPLICATION

This application is based on and claims the benefit of priority from Japanese Patent Application No. 2024-50156, the disclosure of which is incorporated in its entirety herein by reference.

### TECHNICAL FIELD

The present disclosure relates to a driving assistance device and a driving assistance method for a vehicle.

### BACKGROUND

JP 2014-222462 A discloses a collision mitigation device that performs a driving assistance operation of detecting an object in front of an own vehicle using a camera sensor and a radar sensor to mitigate collision with the object. This collision mitigation device calculates fusion information, which is the position of an object, from the detection result by the camera sensor and the radar sensor, judges reliability of the fusion information, and determines an actuation timing of the driving assistance operation depending on the reliability of the fusion information.

### SUMMARY

However, when the object is at close range from the camera, the bottom of the object deviates from the angle of view of the camera, and the state “out of view at close range” in which the object is not correctly detected may occur. Therefore, when the object is located at close range, the detection reliability of the object by the camera decreases. Accordingly, in spite of the fact that the object is present immediately in front of the own vehicle with a high collision probability, the detection reliability of the object is low in the known technology because it is out of view of the camera at close range, with the result that the driving assistance operation is delayed or not actuated in some cases. Such a problem may occur not only with a camera but also when another sensor is used to detect the position of the object. Therefore, there is demand for a technology to appropriately execute the driving assistance operation depending on the detection reliability of the position of the object by two sensors.

According to an aspect of the present disclosure, a driving assistance device is provided. This driving assistance device includes: a position detection unit that executes first position detection processing to detect a first position of an object using an output of a first sensor and second position detection processing to detect a second position of the object using an output of a second sensor; and an operation command generation unit that generates an operation command of a driving assistance operation to reduce a probability of collision between an own vehicle and the object using a detection result of the position detection unit. The operation command generation unit is configured to execute: first processing that judges a detected state of the object detected by the first position detection processing and the second position detection processing corresponds to which of a plurality of detected states including a first detected state and a second detected state having detection reliability lower than that of the first detected state; and second processing that sets a target braking force generated by actuation of an automatic braking to a value lower than when detected state of the object corresponds to the first detected state if a specific condition including that the detected state of the object corresponds to the second detected state is satisfied.

According to an aspect of the present disclosure, a driving assistance device is provided. This driving assistance device includes an electronic control unit including a processor and configured to: execute first position detection processing to detect a first position of an object using an output of a first sensor and second position detection processing to detect a second position of the object using an output of a second sensor; and generate an operation command of a driving assistance operation to reduce a probability of collision between an own vehicle and the object using a detection result of the position detection unit. The electronic control unit is configured to execute: first processing that judges a detected state of the object detected by the first position detection processing and the second position detection processing corresponds to which of a plurality of detected states, including a first detected state and a second detected state having detection reliability lower than that of the first detected state; and second processing that sets a target braking force generated by actuation of an automatic braking to a value lower than when the detected state of the object corresponds to the first detected state, in response to a specific condition including the detected state of the object corresponding to the second detected state is satisfied.

According to an aspect of the present disclosure, a driving assistance method is provided. This driving assistance method includes: a position detection step of executing first position detection processing to detect a first position of an object using an output of a first sensor and second position detection processing to detect a second position of the object using an output of a second sensor; and an operation command generation step of generating an operation command of a driving assistance operation to reduce a probability of collision between an own vehicle and the object using a detection result of the position detection step. The operation command generation step includes executing: first processing that judges a detected state of the object detected by the first position detection processing and the second position detection processing corresponds to which of a plurality of detected states, including a first detected state and a second detected state having detection reliability lower than that of the first detected state; and second processing that sets a target braking force generated by actuation of an automatic braking to a value lower than when the detected state of the object corresponds to the first detected state, if a specific condition including that the detected state of the object corresponds to the second detected state is satisfied.

According to the above driving assistance devices and driving assistance method, the driving assistance operation can be appropriately executed depending on the detection reliability of the object by two sensors. Further, since a slight automatic braking is actuated when the specific condition including that the detected state of the object corresponds to the second detected state is satisfied, the driving assistance operation for reducing a collision probability with the object being present at close range can be appropriately executed while preventing actuation of excessively strong automatic braking.

### BRIEF DESCRIPTION OF THE DRAWINGS

In the accompanying drawings:

FIG. 1 is a block diagram illustrating a configuration of a vehicle control system;

FIG. 2 is an explanatory diagram illustrating a detectable range and an undetectable range of a camera;

FIG. 3 is an explanatory diagram illustrating three detection states;

FIG. 4 is a flowchart illustrating a procedure of driving assistance processing in a first embodiment;

FIG. 5 is an explanatory diagram illustrating an example of a relationship between a movement path of an own vehicle and an object;

FIG. 6 is a flowchart illustrating a procedure of driving assistance processing in a second embodiment; and

FIG. 7 is a flowchart illustrating a procedure of driving assistance processing in a third embodiment.

### DETAILED DESCRIPTION OF EMBODIMENTS

### a. First Embodiment

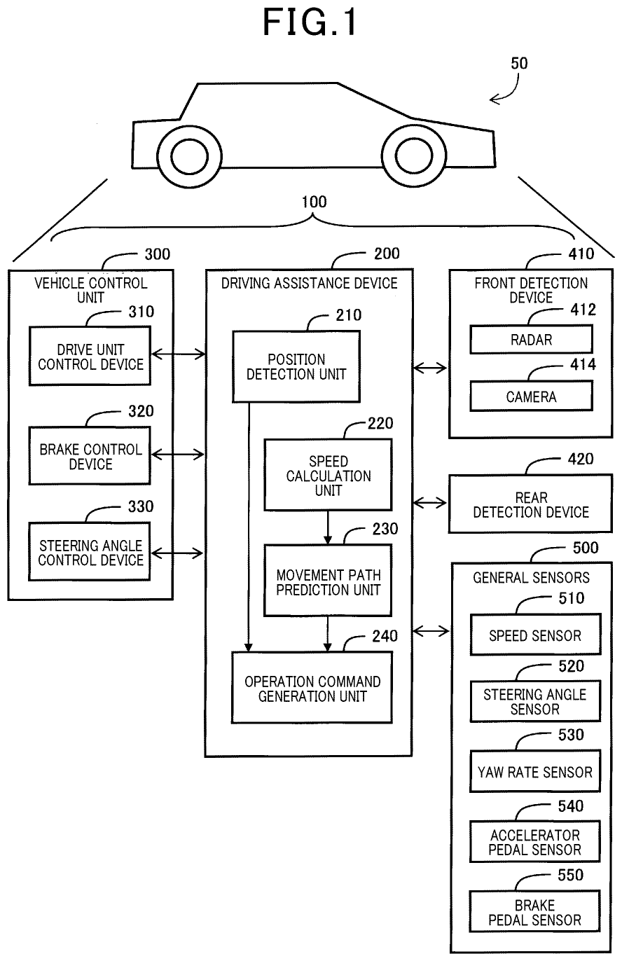

As illustrated in FIG. 1, a vehicle 50 of a first embodiment includes a vehicle control system 100. The vehicle control system 100 includes a driving assistance device 200, a vehicle control unit 300, a front detection device 410, a rear detection device 420, and general sensors 500. As described herein, the vehicle 50 is also referred to as an “own vehicle 50”.

The vehicle control unit 300 includes a drive unit control device 310, a brake control device 320, and a steering angle control device 330. The drive unit control device 310 has a function of controlling a drive unit (not illustrated) that drives wheels of the vehicle 50. As the drive unit of the wheels, one or more prime movers of an internal combustion engine and an electric motor can be used. The brake control device 320 executes brake control of the vehicle 50. The brake control device 320 is configured as, for example, an electronically controlled brake system (ECB). The steering angle control device 330 controls the steering angle of the wheels of the vehicle 50. The steering angle means the average steering angle of two front wheels of the vehicle 50. The steering angle control device 330 is configured as, for example, an electric power steering system (EPS).

The front detection device 410 uses a vehicle-mounted sensor to acquire information regarding various objects such as bodies and road facilities (a lane, an intersection, a traffic light, etc.) being present in front of the own vehicle 50. In the present embodiment, the front detection device 410 has a plurality of distance measuring devices including a radar 412 and a camera 414. As the radar 412, various radars that emit electromagnetic waves, such as a light detection and ranging (LiDAR) and a millimeter-wave radar, may be used. As the camera 414, a single lens camera and a stereo camera may be used. The camera 414 is preferably a color camera in order to distinguish the color of the object. The front detection device 410 may include another distance measuring device such as an ultrasonic sensor.

The rear detection device 420 acquires information regarding various objects such as bodies and road facilities being present in the rear of the own vehicle 50. The rear detection device 420 can also be configured to include vehicle-mounted sensors similar to the front detection device 410.

In the below-explained embodiment, an example in which the own vehicle 50 moves forward, and the position of the object is detected using the front detection device 410 will be described. However, the present disclosure is also applicable to a case where the own vehicle 50 moves backward.

The general sensors 500 include a speed sensor 510, a steering angle sensor 520, a yaw rate sensor 530, an accelerator pedal sensor 540, and a brake pedal sensor 550. The general sensors 500 are general sensors necessary for driving the vehicle 50.

The driving assistance device 200 is configured as an electronic control unit (ECU) containing a processor and a memory. In the driving assistance device 200, the processor executes a computer program stored in a nonvolatile storage medium to realize functions of a position detection unit 210, a speed calculation unit 220, a movement path prediction unit 230, and an operation command generation unit 240. Note that a part of the functions of the driving assistance device 200 may be realized by a hardware circuit.

The position detection unit 210 detects the position of the object using outputs of sensors of the front detection device 410 or the rear detection device 420. Examples of the object include movable bodies such as other vehicles and people as well as stationary bodies being present on roads. The position detection unit 210 is configured to execute first position detection processing to detect a first position of an object using an output of the radar 412 and second position detection processing to detect a second position of the object using an output of the camera 414.

In the first position detection processing using an output of the radar 412, the position and shape of the object are recognized based on a wave reflected from the object. In the second position detection processing using an output of the camera 414, the position and shape of the object are recognized based on an image of the object. The second position detection processing may further include processing to determine the type of the object. Specifically, the second position detection processing preferably includes processing to identify vehicles, people, and structures such as a wall and a guard rail as different types of objects.

The position detection unit 210 may also be configured to prepare fusion information representing the synthesized position of the object by synthesizing the first position of the object detected using an output of the radar 412 and the second position of the object detected using an output of the camera 414. As the processing to prepare the fusion information, for example, the processing to acquire fusion information disclosed in JP 2014-222462 A described above can be used. Further, the position detection unit 210 may also be configured to prepare the fusion information by another method.

In the present embodiment, the radar 412 is equivalent to the “first sensor”, and the camera 414 is equivalent to the “second sensor”. However, the present disclosure is also applicable when another type of sensor is used as the first sensor or the second sensor.

The speed calculation unit 220 calculates a current speed and a current acceleration of the own vehicle 50. The current speed can be obtained from the detection result of the speed sensor 510. The current acceleration can be calculated from a change in the current speed of the own vehicle 50.

The movement path prediction unit 230 predicts a movement path of the own vehicle 50. The movement path of the own vehicle 50 is a temporal positional change of the own vehicle 50. The movement path of the own vehicle 50 can be predicted using the current speed and the acceleration as well as a directional change of the own vehicle 50. The directional change of the own vehicle 50 is calculated from the detection results of the steering angle sensor 520 and the yaw rate sensor 530.

Using the processing results of the position detection unit 210 and the movement path prediction unit 230, the operation command generation unit 240 generates an operation command of the driving assistance operation for reducing the probability of collision between the own vehicle 50 and the object. The driving assistance operation includes an automatic braking. In the present disclosure, the “automatic braking” can include both a braking executed by a system when a driver is not pressing a brake pedal at all and a braking executed by a system for supporting or amplifying a braking force when the driver is pressing a brake pedal. The driving assistance operation may be configured to further include generation of a warning alert and display of a warning. The generation of a warning alert can be performed using a speaker of the own vehicle 50. The display of a warning can be performed using an instrument panel of the own vehicle 50.

The operation command prepared in the operation command generation unit 240 is transmitted to various devices such as the brake control device 320. According to the given operation command, the brake control device 320 executes an automatic braking to avoid or mitigate collision.

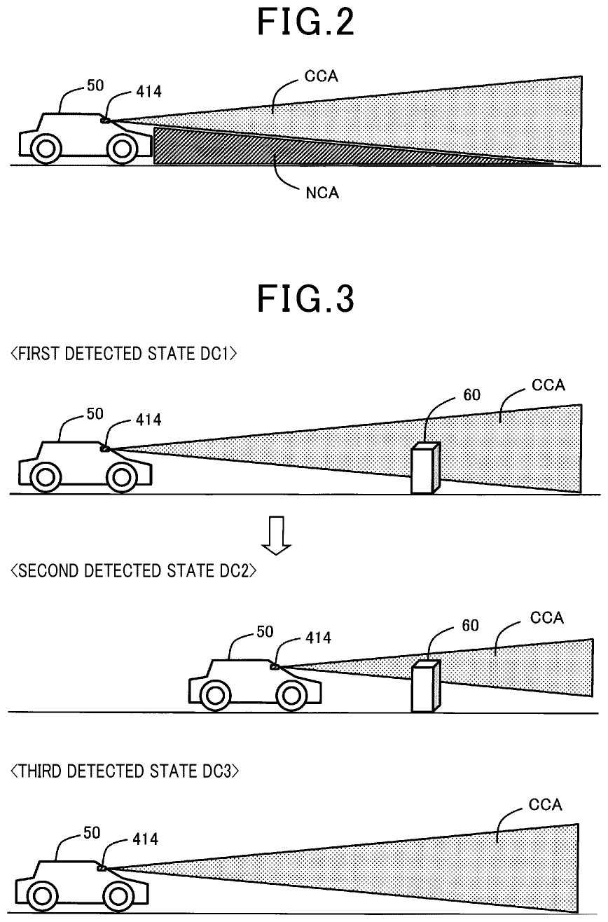

As illustrated in FIG. 2, the camera 414 has a detectable range CCA and an undetectable range NCA. The detectable range CCA is a range encompassing the angle of view of the camera 414, and the undetectable range NCA is a range deviating from the angle of view of the camera 414.

As illustrated in FIG. 3, a detected state DC in the position detection of an object 60 using the radar 412 and the camera 414 is classified into a first detected state DC1, a second detected state DC2, and a third detected state DC3. These states are as follows.

### <First Detected State DC1>

The first detected state DC1 is a state in which the reliability of the first position detection processing using the radar 412 is equal to or greater than a first reliability threshold, and the reliability of the second position detection processing using the camera 414 is equal to or greater than a second reliability threshold.

As the reliability of the first position detection processing using the radar 412, for example, an index value corresponding to the received signal strength of the reflective wave from the object 60 can be used. As the reliability of the second position detection processing using the camera 414, for example, an index value corresponding to the matching degree between the object 60 contained in a past image and the object 60 contained in a latest image can be used. The first reliability threshold and the second reliability threshold are each empirically preset. The first detected state DC1 is a state in which the object 60 has been able to be correctly detected up to the present time by the camera 414, and both the detection reliability by the radar 412 and the detection reliability by the camera 414 are high. In this state, the reliability of fusion information representing the synthesized position of the first position of the object detected using an output of the radar 412 and the second position of the object detected using an output of the camera 414 is also high. Therefore, it is preferable to prepare fusion information in the first detected state DC1.

### <Second Detected State DC2>

The second detected state DC2 is a state in which the reliability of the first position detection processing using the radar 412 is equal to or greater than the first reliability threshold, and the reliability of the second position detection processing using the camera 414 is less than the second reliability threshold.

As illustrated in FIG. 3, the second detected state DC2 occurs when the own vehicle 50 proceeds from the first detected state DC1 and approaches the object 60. That is, when the own vehicle 50 proceeds and approaches within a short distance to the object 60, the bottom of the object 60 deviates from the detectable range CCA of the camera 414, resulting in occurrence of the state “out of view at close range” in which the object 60 cannot be correctly detected. Since the object 60 is within a short distance in this second detected state DC2, the driver of the own vehicle 50 may recognize a collision probability and press a brake pedal. Therefore, when the operation command generation unit 240 actuates the driving assistance operation, the strength of an automatic braking is preferably lighter than that of a normal automatic braking for collision reduction, in order to decrease the feeling of unnecessary actuation. Further, in the second detected state DC2, the object 60 may not actually be present, therefore the strength of an automatic braking is preferably reduced in order to decrease the feeling of unnecessary actuation. Note that since the reliability of fusion information is lower in the second detected state DC2 than in the first detected state DC1, fusion information using the detection result at the present time may not be prepared. When fusion information using the detection result at the present time is not prepared, predicted fusion information representing a position extrapolated from a position represented by past fusion information may be prepared. Alternatively, the first position of the object 60 detected using the radar 412 may be used as the position of the object 60, without preparing predicted fusion information.

### <Third Detected State DC3>

The third detected state DC3 is a state having no history in which the camera 414 has correctly detected the object 60.

Since the third detected state DC3 is a state in which the object 60 is not present in front of the own vehicle 50, it is preferable to prohibit an automatic braking for decreasing the probability of collision. In the third detected state DC3, the first position of the object 60 detected using the radar 412 is used as the position of the object 60.

The operation command generation unit 240 may be configured to recognize a state other than the above-described three detected states DC1 to DC3 as the detected state DC. However, the operation command generation unit 240 is preferably configured to recognize as the detected state DC at least the first detected state DC1 and the second detected state DC2.

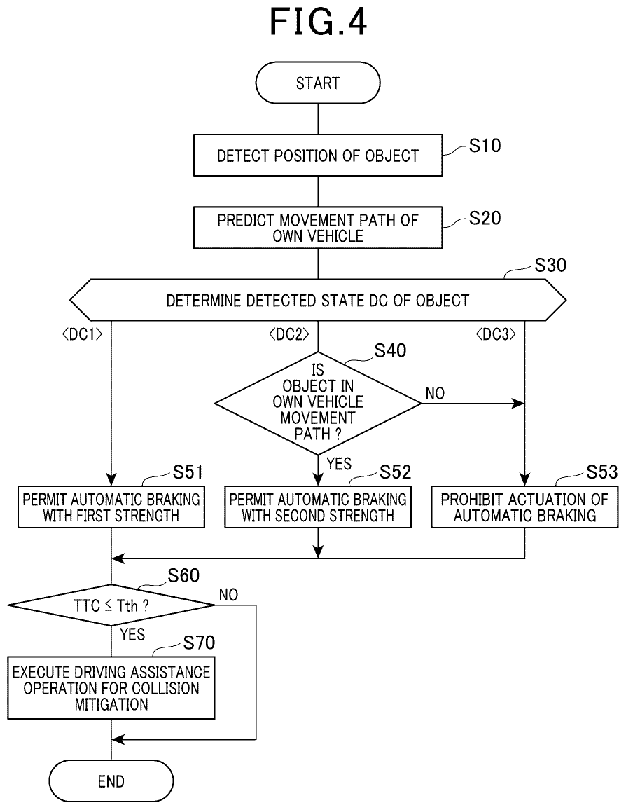

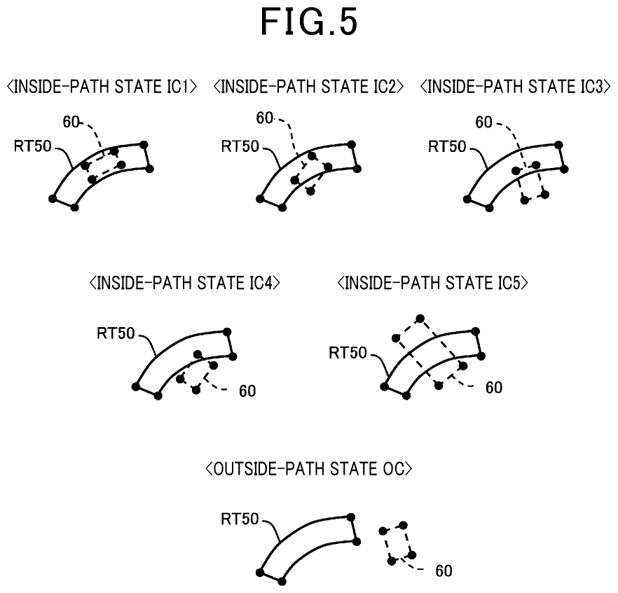

The driving assistance processing illustrated in FIG. 4 is periodically repeated after the own vehicle 50 starts up. In step S10, the position detection unit 210 detects the position of the object 60. Specifically, the position detection unit 210 executes first position detection processing to detect a first position of an object 60 using an output of the radar 412 and executes second position detection processing to detect a second position of the object 60 using an output of the camera 414.

In step S20, the movement path prediction unit 230 predicts the movement path of the own vehicle 50. The “movement path” means the temporal positional change of the own vehicle 50 and is a two-dimensional path that spreads in the width direction of the own vehicle 50 around a path line on which the center of the own vehicle 50 runs. The prediction of the movement path is executed using the speed and acceleration of the own vehicle 50 calculated in the speed calculation unit 220.

In step S30, the operation command generation unit 240 determines which of the above-described three detected states DC1 to DC3 the detected state DC of the object 60 by the position detection unit 210 corresponds to. The processing proceeds to step S51 described later when corresponding to the first detected state DC1, to step S40 described later when corresponding to the second detected state DC2, and to step S53 described later when corresponding to the third detected state DC3.

When the detected state DC corresponds to the first detected state DC1, the operation command generation unit 240 permits an automatic braking with first strength as the driving assistance operation in step S51. This “first strength” may be set to, for example, the same strength as that of a normal automatic braking for collision reduction.

When the detected state DC corresponds to the second detected state DC2, the operation command generation unit 240 judges whether the object 60 is present in the movement path of the own vehicle 50 in step S40.

As illustrated in FIG. 5, the position of the object 60 can be classified into inside-path states IC1 to IC5 in which the object 60 is present inside the movement path RT50 of the own vehicle 50 and an outside-path state OC in which the object 60 does not exist in the movement path RT50 of the own vehicle 50. As understood from these examples, the object 60 is recognized as being present in the movement path of the own vehicle 50 if the object 60 and the movement path RT50 of the own vehicle 50 partially overlap. On the other hand, the object 60 is recognized as being not present in the movement path of the own vehicle 50 when the object 60 and the movement path RT50 of the own vehicle 50 do not overlap at all.

When the object 60 is judged as being present in the movement path of the own vehicle 50 in step S40, the processing proceeds to step S52, and the operation command generation unit 240 permits an automatic braking with second strength as the driving assistance operation. This “second strength” is a value smaller than the “first strength” permitted in step S41 and means a braking having a smaller braking force. Note that since a braking force generated by the actuation of an automatic braking varies depending on a road surface state, the phrase “smaller braking force” exactly means that a target braking force is smaller. On the other hand, when the object 60 is judged as being not present in the movement path of the own vehicle 50 in step S40, the processing proceeds to step S53.

In step S53, the operation command generation unit 240 prohibits using an automatic braking as the driving assistance operation. That is, when the detected state corresponds to the third detected state DC3, an automatic braking for reducing the probability of collision is prohibited. Further, an automatic braking for reducing the probability of collision is also prohibited when the detected state corresponds to the second detected state DC2, but the object 60 is not present in the movement path of the own vehicle 50. This can prevent the actuation of unnecessary automatic braking.

In step S60, the operation command generation unit 240 calculates a time to collision TTC using the relationship between the movement path of the own vehicle 50 and the position of the object 60, and judges whether the time to collision TTC is equal to or less than a time threshold Tth. The time to collision TTC is a time to the time when the own vehicle 50 and the object 60 are predicted to collide. The judgment of step S60 is equivalent to a collision judgment as to whether there is a probability of collision between the own vehicle 50 and the object 60. When the time to collision TTC is greater than the time threshold Tth, the processing of FIG. 4 is terminated. On the other hand, when the time to collision TTC is equal to or less than the time threshold Tth, the processing proceeds to step S70.

In step S70, the operation command generation unit 240 generates an operation command of the driving assistance operation for mitigating collision and transmits the operation command to the devices such that the driving assistance operation is executed. At this time, the operation command generation unit 240 may judge whether to execute the driving assistance operation for mitigating collision in further consideration of the manipulation of a driver. For example, when a non-actuation condition such as the driver steering or continuing to strongly press the accelerator pedal is satisfied, the driving assistance operation for mitigating collision may not be executed.

When use of an automatic braking is permitted as the driving assistance operation, the operation command generation unit 240 transmits an emergency braking command to the brake control device 320 such that an automatic braking is actuated. As a result, collision between the own vehicle 50 and the object 60 can be avoided or mitigated. Further, when generation of a warning alert or display of a warning is performed as the driving assistance operation, the warning is executed by transmitting a warning operation command to a speaker or an instrument panel of the own vehicle 50.

In the driving assistance processing illustrated in FIG. 4, when a specific condition including both a first condition of “corresponding to the second detected state DC2” and a second condition that “the object 60 is present in the movement path of the own vehicle 50” is satisfied, a target braking force generated by the actuation of an automatic braking is set to a value lower than when corresponding to the first detected state DC1. However, the second condition may be omitted, and if the first condition of “falling under the second detected state DC2” is satisfied, the target braking force generated by the actuation of an automatic braking may be set to a value lower than when corresponding to the first detected state DC1. Further, the specific condition may be set to include a condition other than the above-described second condition.

According to the above-described first embodiment, if the specific condition including corresponding to the second detected state DC2 is satisfied, an automatic braking with a braking force lower than when corresponding to the first detected state DC1 is selected as the driving assistance operation. Therefore, the driving assistance operation can be adequately executed depending on the detection reliability of the object 60 by the radar 412 and the camera 414. In addition, the driving assistance operation for reducing the probability of collision with the object 60 located at close range while preventing the actuation of an excessively strong automatic braking can be adequately executed. Furthermore, an automatic braking is prohibited if the detected state corresponds to the second detected state DC2, but the specific condition is not satisfied due to a factor other than corresponding to the second detected state DC2, so that actuation of unnecessary automatic braking can be prevented.

### B. Second Embodiment

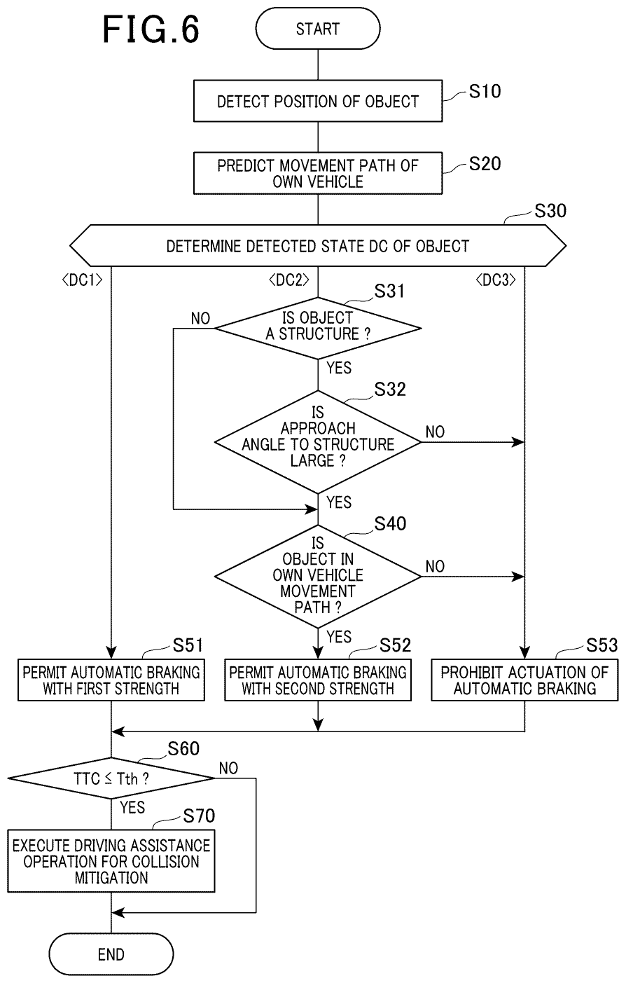

The driving assistance processing illustrated in FIG. 6 is the same as in FIG. 4 except that steps S31 and S32 are added after step S30 of FIG. 4. The device configuration of the second embodiment is the same as the device configuration of the first embodiment.

In step S31, the operation command generation unit 240 judges whether the object 60 is a structure such as a wall or a guard rail. Whether the object 60 is a structure can be judged from, for example, the result of the second position detection processing in the position detection unit 210 using an output of the camera 414. If the object 60 is not a structure, the processing proceeds to step S40 to execute the same processing as in the first embodiment. On the other hand, if the object 60 is a structure, the processing proceeds to step S32.

In step S32, the operation command generation unit 240 judges whether the approach angle of the object 60 as a structure is sufficiently large. In other words, it is judged whether a condition that the approach angle of the own vehicle 50 to the object 60 as a structure is equal to or greater than an angle threshold is satisfied. Here, the “approach angle” means an angle that is the smaller of two angles formed by the surface of the object 60 and the movement path of the own vehicle 50. Therefore, the approach angle can be a value in a range of 0 to 90 degrees. When the approach angle to a structure such as a wall and a guard rail is small, there is a probability that a driver avoids the structure by steering, so that an automatic braking is not necessary. Therefore, when the approach angle to the object 60 as a structure is less than an angle threshold, the processing proceeds to step S53, and an automatic braking is prohibited. As a result, actuation of unnecessary automatic braking can be prevented. Further, when the approach angle to a structure is equal to or greater than an angle threshold, the proceeding proceeds to step S40.

As explained in the first embodiment, when it is judged that the object 60 is present in the movement path of the own vehicle 50 in step S40, the processing proceeds to step S52, and the automatic braking with second strength is permitted as the driving assistance operation. As a result, weak automatic braking can be executed as the driving assistance operation.

As described above, in the second embodiment, an automatic braking with a braking force smaller than when corresponding to the first detected state DC1 is selected as the driving assistance operation, if a specific condition including the first condition of “corresponding to the second detected state DC2”, the second condition that “the object 60 is present in the movement path of the own vehicle 50”, and a third condition that “the object 60 is a structure, and the approach angle of the own vehicle 50 to the object 60 is equal to or greater than an angle threshold” is satisfied. Further, even when a condition that “the object 60 is not a structure” is satisfied instead of the above-described third condition, the “specific condition” is also satisfied, and an automatic braking with a small braking force is selected. Therefore, the driving assistance operation can be adequately executed depending on the detection reliability of the object 60 by the radar 412 and the camera 414. Further, in the second embodiment, when the first condition of “corresponding to the second detected state DC2” is satisfied, but the “specific condition” is not satisfied, an automatic braking is also prohibited in the same manner as in the first embodiment, so that unnecessary automatic braking can be prevented from being executed as the driving assistance operation.

### C. Third Embodiment

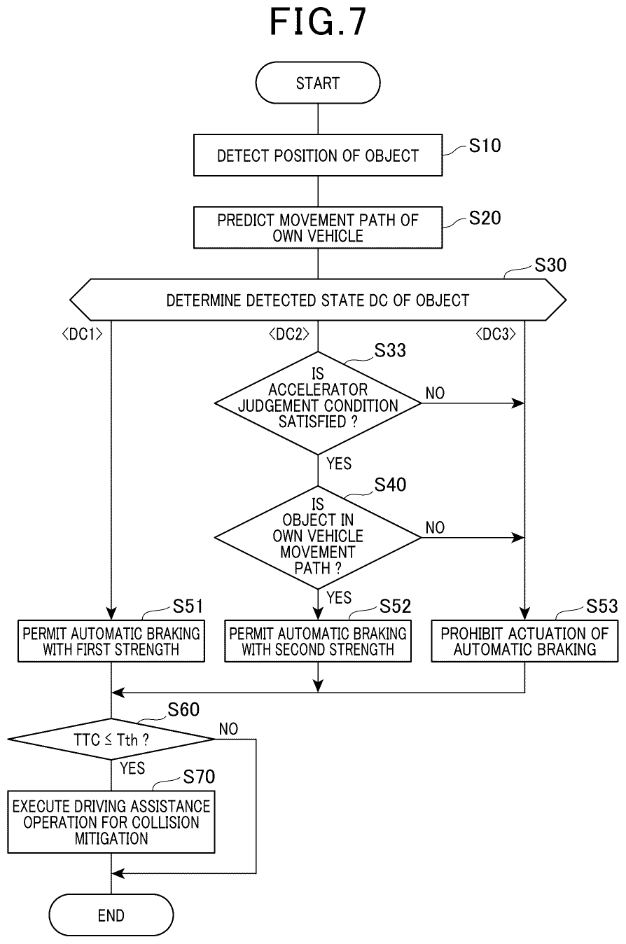

The driving assistance processing illustrated in FIG. 7 is the same as in FIG. 4, except that step S33 is added after step S30 of FIG. 4. The device configuration of the third embodiment is the same as the device configuration of the first embodiment.

In step S33, the operation command generation unit 240 judges whether an accelerator judgment condition including that the manipulation amount of an accelerator pedal or the rate of change with time thereof is equal to or greater than a threshold is satisfied. The accelerator judgment condition is a condition representing a probability that an accelerator pedal is erroneously pressed by a driver. The accelerator judgment condition can also be called an “erroneous pressing judgment condition”. However, even when the accelerator judgment condition is satisfied, erroneous pressing is not necessarily present, and a probability of erroneous pressing is merely suggested. A usable example of the accelerator judgment condition is any of the following.

### <Accelerator Judgment Condition J1>

The accelerator judgment condition J1 is a condition that “the manipulation amount of an accelerator pedal is equal to or greater than a manipulation amount threshold.”

The probability of erroneous pressing is judged as being present when the judgment condition J1 is satisfied, and as being absent when the judgment condition J1 is not satisfied.

### <Accelerator Judgment Condition J2>

The accelerator judgment condition J2 is a condition that “the manipulation amount of an accelerator pedal is equal to or greater than a manipulation amount threshold, and the rate of change with time of the manipulation amount is equal to or greater than a change rate threshold.”

The probability of erroneous pressing is judged as being present when the judgment condition J2 is satisfied, and as being absent when the judgment condition J2 is not satisfied.

### <Accelerator Judgment Condition J3>

The accelerator judgment condition J3 is a condition including a first condition that “the manipulation amount of an accelerator pedal is equal to or greater than a first manipulation amount threshold” and a second condition that “the manipulation amount of an accelerator pedal is equal to or greater than a second manipulation amount threshold, and the rate of change with time of the manipulation amount is equal to or greater than a change rate threshold.”

The probability of erroneous pressing is judged as being present when at least one of the first condition and the second condition is satisfied, and as being absent when both the first condition and the second condition are not satisfied. Note that the second manipulation amount threshold is preferably set to a value smaller than the first manipulation amount threshold. For example, the first manipulation amount threshold is preferably set to a value equivalent to an accelerator opening of 90% or more which is close to a fully open accelerator state. The second manipulation amount threshold is preferably set to, for example, a value equivalent to an accelerator opening in a range of 50% to 80%.

The “manipulation amount of an accelerator pedal” means the pressing amount of an accelerator pedal. In the present embodiment, the accelerator judgment condition J3 is used. The accelerator judgment condition J3 is preferable in order to correctly recognize a state in which the driver strongly or quickly presses an accelerator pedal instead of a brake pedal by mistake so that the acceleration of the own vehicle 50 is predicted to rapidly increase immediately thereafter. However, another judgment condition may be adopted. The manipulation amount threshold and the change rate threshold are empirically set.

When the accelerator judgment condition is not satisfied in step S33, the processing proceeds to step S53, and an automatic braking is prohibited. As a result, actuation of unnecessary automatic braking can be prevented. When the accelerator judgment condition is satisfied, the processing proceeds to step S40.

As explained in the first embodiment, when it is judged that the object 60 is present in the movement path of the own vehicle 50 in step S40, the processing proceeds to step S52, and the automatic braking with second strength is permitted as the driving assistance operation. As a result, weak automatic braking can be executed as the driving assistance operation.

Note that when the accelerator judgment condition is satisfied, the time to collision TTC may be calculated in step S60 using as the own vehicle acceleration a value that is the larger of a current acceleration of the own vehicle 50 and a set acceleration larger than the current acceleration. The current acceleration of the own vehicle 50 is a current acceleration calculated from an output of the speed sensor 510. The “set acceleration” is a preset acceleration and is set to a value that is equal to or greater than the maximum value of an acceleration predicted to occur in the own vehicle 50 when an accelerator pedal is erroneously pressed. The set acceleration is preferably set to, for example, a value that is equal to or greater than the maximum acceleration obtained when the manipulation amount of an accelerator pedal reaches the maximum value (accelerator opening: 100%) under the standard running condition that the own vehicle 50 runs on a flat road. The maximum acceleration can be confirmed by measuring the acceleration when the own vehicle 50 is accelerated from a stopped state to an accelerator opening of 100%. Since the set acceleration is determined under the condition that the own vehicle 50 is running on a flat road, there is a probability that, for example, the own vehicle 50 will be accelerated at an acceleration larger than this set acceleration if the own vehicle 50 is running down a slope. Further, when the own vehicle 50 is modified for some reason, there is also a probability that an acceleration equal to or greater than the set acceleration will occur. Therefore, when the accelerator judgment condition is satisfied, collision can be avoided or mitigated even if the speed of the own vehicle 50 rapidly increases, by calculating the time to collision TTC using as the own vehicle acceleration a value that is the larger of the preset set acceleration and the current acceleration.

As described above, in the third embodiment, an automatic braking with a braking force smaller than when corresponding to the first detected state DC1 is selected as the driving assistance operation if a specific condition including the first condition of “corresponding to the second detected state DC2”, the second condition that “the object 60 is present in the movement path of the own vehicle 50”, and a third condition that “an accelerator judgment condition including that the manipulation amount of an accelerator pedal of the own vehicle or the rate of change with time thereof is equal to or greater than a threshold is satisfied” is satisfied. Therefore, the driving assistance operation can be adequately executed depending on the detection reliability of the object 60 by the radar 412 and the camera 414. Further, in the third embodiment, an automatic braking is also prohibited in the same manner as in the first embodiment if the first condition of “corresponding to the second detected state DC2” is satisfied, but the “specific condition” is not satisfied, so that unnecessary automatic braking can be prevented from being executed as the driving assistance operation.

Note that in step S33, the state of a driver detected by a driver status monitor may also be utilized together with the manipulation amount of an accelerator pedal to judge whether the accelerator judgment condition is satisfied. Further, when the reliability of driving by the driver is low (such as in the case of an elderly person or the like) from the detection result of the driver status monitor, the threshold Tth of the time to collision TTC may be set to a larger value in step S60 to actuate an automatic braking earlier.

The third embodiment can also be applied to the second embodiment. For example, step S33 of FIG. 7 may be inserted between step S32 and step S40 of FIG. 6. However, the order of the steps of FIG. 4, FIG. 6, and FIG. 7 can be appropriately changed.

The present disclosure is not limited to the above-described embodiments or modifications thereof, and can be realized in various aspects without departing from the scope thereof.

What is claimed is:

1. A driving assistance device, comprising:
a position detection unit configured to execute first position detection processing to detect a first position of an object using an output of a first sensor and second position detection processing to detect a second position of the object using an output of a second sensor; and
an operation command generation unit configured to generate an operation command of a driving assistance operation to reduce a probability of collision between an own vehicle and the object using a detection result of the position detection unit, wherein
the operation command generation unit is configured to execute
first processing that judges a detected state of the object detected by the first position detection processing and the second position detection processing corresponds to which of a plurality of detected states, including a first detected state and a second detected state having detection reliability lower than that of the first detected state; and
second processing that sets a target braking force generated by actuation of an automatic braking to a value lower than when the detected state of the object corresponds to the first detected state, in response to a specific condition including that the detected state of the object corresponds to the second detected state being satisfied.

2. The driving assistance device according to claim 1,
wherein when the detected state of the object corresponds to the second detected state, but the specific condition is not satisfied due to a factor other than the detected state of the object corresponding to the second detected state, the operation command generation unit is configured to prohibit the automatic braking as the driving assistance operation.

3. The driving assistance device according to claim 2, wherein
the first sensor is a radar, and
the second sensor is a camera.

4. The driving assistance device according to claim 3, wherein
the first detected state is a state that a first reliability of the first position detection processing using the radar is equal to or greater than a first reliability threshold, and a second reliability of the second position detection processing using the camera is equal to or greater than a second reliability threshold, and
the second detected state is a state that the first reliability is equal to or greater than the first reliability threshold, and the second reliability is less than the second reliability threshold.

5. The driving assistance device according to claim 2, further comprising
a movement path prediction unit configured to predict a movement path of the own vehicle,
wherein the specific condition includes a first condition that the detected state of the object corresponds to the second detected state and a second condition that the object is present in the movement path predicted by the movement path prediction unit.

6. The driving assistance device according to claim 5,
wherein the specific condition further includes a condition that the object is a structure, and an approach angle of the own vehicle to the object is equal to or greater than an angle threshold.

7. The driving assistance device according to claim 5,
wherein the specific condition further includes a condition that an accelerator judgment condition, including that a manipulation amount of an accelerator pedal of the own vehicle or a rate of change with time of the manipulation amount is equal to or greater than a threshold, is satisfied.

8. The driving assistance device according to claim 7,
wherein when the accelerator judgment condition is satisfied, the operation command generation unit is configured to calculate a time to collision using as an own vehicle acceleration a value that is the larger of a current acceleration of the own vehicle and a set acceleration larger than the current acceleration.

9. A driving assistance device, comprising:
an electronic control unit comprising a processor and configured to:
execute first position detection processing to detect a first position of an object using an output of a first sensor and second position detection processing to detect a second position of the object using an output of a second sensor; and
generate an operation command of a driving assistance operation to reduce a probability of collision between an own vehicle and the object using a detection result of the position detection unit, wherein
the electronic control unit is configured to execute
first processing that judges a detected state of the object detected by the first position detection processing and the second position detection processing corresponds to which of a plurality of detected states, including a first detected state and a second detected state having detection reliability lower than that of the first detected state; and
second processing that sets a target braking force generated by actuation of an automatic braking to a value lower than when the detected state of the object corresponds to the first detected state, in response to a specific condition including that the detected state of the object corresponds to the second detected state being satisfied.

10. A driving assistance method, comprising:
a position detection step of executing first position detection processing to detect a first position of an object using an output of a first sensor and second position detection processing to detect a second position of the object using an output of a second sensor; and
an operation command generation step of generating an operation command of a driving assistance operation to reduce a probability of collision between an own vehicle and the object using a detection result of the position detection step, wherein
the operation command generation step includes executing
first processing that judges a detected state of the object detected by the first position detection processing and the second position detection processing corresponds to which of a plurality of detected states, including a first detected state and a second detected state having detection reliability lower than that of the first detected state; and
second processing that sets a target braking force generated by actuation of an automatic braking to a value lower than when the detected state of the object corresponds to the first detected state, in response to a specific condition including that the detected state of the object corresponds to the second detected state being satisfied.
